(19) United States
(12) Patent Application Publication
(10) Pub. No.: US 2007/0299375 A1
(43) Pub. Date: Dec. 27, 2007

(54) Biomechanical Stimulation Device

(75) Inventors: Ulrich Hansenberger, Oberuzwil (CH); Viktor Wick, Niederburen (CH); Felix Lenz, Niederburen (CH)

Correspondence Address: MCDONALD HOPKINS LLC, 600 Superior Avenue, East, Suite 2100, CLEVELAND, OH, 44114-2653, US

(73) Assignee: VISION INDUSTRIAL SERVICES GMBH, Appenzell (CH)

(21) Appl. No.: 10/596,235

(22) PCT Filed: Dec. 1, 2004
(86) PCT No.: PCT/EP04/13595

§ 371 Date: Jun. 18, 2007

(30) Foreign Application Priority Data
Dec. 5, 2003 (EP) 03028004.4

(51) Int. Cl. A61H 1/00

(52) U.S. Cl. 601/86

(57) ABSTRACT

The invention relates to a device for carrying out biomechanical stimulation, comprising a base plate (1), a pedestal (2) connected to the base plate (1), and a platform (3) connected to said pedestal (2) via a driving device. The invention is characterized in that the platform (3) executes a circular or elliptical movement about an axis, which is located outside of the center of gravity of the platform (3) whereby undergoing a parallel displacement. The device is preferably designed in such a manner that the platform (3) has an ergonomic shape and has a surface area smaller than that of the base plate (1).

The present invention is related to an improved device for biomechanical stimulation of muscles.

The biomechanical muscle stimulation (BMS) was developed in Russia at the end of the 1970 by Prof. Nazarov and primarily applied in the field of competitive sport. The BMS relies on an exclusively mechanical action onto the human body by means of vibration having respectively a specific frequency and a specific amplitude which are selected in accordance with the desired application. The vibrations which resemble the natural vibrations of the body and imitate the same are acting upon the strained or expanded muscles along the muscle fibre. By purposively influencing the vibrational parameters of the body, in the BMS thus positive effects on e.g. the circular or the lymphatic system are generated.

For example, due to the improved movements of the muscles caused by the BMS a significantly increased blood circulation of the muscle respectively of the concerned body part occurs. This can be used for the treatment of diseases such as disturbances of the peripheral blood circulation.

On the other hand, with the aid of the BMS one can also specifically evoke a build-up of muscles which can be exploited in the area of sport, but also in the health area—for example for the build-up of muscles in the course of recovery treatments.

Moreover, the BMS can be used in the cosmetic area e.g. against the generation of wrinkles or cellulites.

In the prior art there have already been described devices for carrying out the BMS, e.g. in DE-A-199 44 456, DE-U-201 16 277 or in DE-U-202 19 435. Therein, the BMS is carried out using randomly generated vibrations in more or less linear (vertical) direction. A lift is generated which has an adverse influence on the user. Moreover, those devices are thus construed that only a limited number of body parts, e.g. only the leg or arm region, can be treated with the BMS.

It was the object of the present invention to provide a device for an improved biomechanical stimulation.

This object is solved by a device according to claim 1.

It has been surprisingly found that the BMS can be advantageously carried out if the stimulation is generated by a uniform circular or elliptical movement. In contrast to the devices of the prior art, with the device according to the present invention thus not only a force vertical to the platform is exerted but also a traction force substantially parallel to the platform. This leads to a significantly improved biomechanical stimulation of the body part which is present in the platform.

According to the present invention, thus a device is provided comprising a base plate, a pedestal connected with said base plate and a platform connected to said pedestal via a driving device, characterized in that the platform executes a circular or elliptical movement about an axis which is located outside of the centre of gravity of the platform, thereby undergoing a parallel displacement.

The device according to the present invention comprises a base plate allowing a stable provision of said device on a flat surface. According to the invention, additional weights may be preferably provided on said base plate in order to improve the stability by fixing said base plate in particular when using said device with high frequencies.

A pedestal is provided which is connected to said base plate. Preferably, said pedestal has an L-form, the shorter end thereof being tightly connected to said base plate, and the longer end thereof extending upwards vertically to the base plate. According to the present invention, by the term “L-form” also a form is understood in which said two portions are not forming a right angle or wherein the larger portion is bent. During the use of the device according to the present invention, a user may hold himself at this pedestal. According to a preferred embodiment of the present invention, there are provided means for operating the device at said pedestal. Particularly preferred is an embodiment wherein over substantially the entire length of the longer portion of the pedestal in L-form in direction to the base plate and a platform there is provided a ribbon having an electric connection to the driving unit. By repeatedly pressing said ribbon, the user can start or stop the operation of the device of the present invention. According to a further preferred embodiment, two grips are provided at the upper end of the pedestal. A user may hold himself at these grips. Of course, also other common holding means can be used.

For better transportation, the device of the present invention is provided with at least one wheel. Preferably, in the vicinity of the connection of pedestal and base plate there are provided two wheels which are in particular located beside the pedestal at its lower end.

The device of the present invention is provided with a platform which is moveably connected with the pedestal via a driving unit. Preferably, the shorter portion of the pedestal having an L-form is situated on a portion of the base plate. The driving unit is connected with this portion of the pedestal. Preferably, there is an opening in this portion of the pedestal through which the driving unit extends. The platform is connected with said driving unit via bearings such that it can be moved in the desired circular or elliptical movement.

Preferably, on the portion of the base plate at which the pedestal is provided and above which the platform is located, there is a cover shielding the driving unit from the outside.

According to the present invention it is particularly preferred that the platform has an ergonomic form. According to the pre-sent invention, by “ergonomic form” a form is meant which does not comprise any corners or edges. In this way, the platform may be used from all directions without any inconvenience or even risk of injury for the user. According to the present invention it is preferred that the platform is oval.

According to the present invention it is particularly preferred that the platform has an ergonomic form and a lower surface area than the surface of the base plate. This enables the user to stand on the base plate, which improves the stability of the device during usage, and to simultaneously use the device by applying body part, e.g. a leg or an arm, onto the platform. Because of its ergonomic form, the platform is thereby accessible from each direction. According to the present invention it is preferred that the surface area of the platform is 30 to 70% of the surface area of the base plate. Upper and lower limits are due to the fact that on the one hand the platform has to possess a certain surface area for being usable, and on the other the advantages herein described cannot be realised anymore in case that the platform has a too large surface area, since in that case the user cannot stand any longer on the base plate during usage.

Accordingly, with the device of the invention, a plurality of exercises may be carried out. In contrast thereto, with the devices of the prior art it is only possible to carry out a limited amount of exercises. Because of the specific features of the device, the application possibilities for the device of the present invention are significantly increased.

According to a further embodiment of the device of the present invention, there are provided openings in the platform. Through these openings, there can be provided, for example, cords or ribbons which are thus connected to the platform. With these cords or ribbons further exercises may be carried out. For example, during usage of the device, a user may stand on the base plate and tear the cords or ribbons, or wind these cords or ribbons around a body part and use the device in such a manner.

During usage, the platform executes a uniform circular or elliptical movement. In contrast to the devices of the prior art, which exercise a random movement, in the case of the device of the present invention the movement is forced and absolutely uniform. It has been found that in that way the biomechanical muscle stimulation may be carried out in a much more efficient way than in a case where the BMS is carried out by random and therefore non-uniform movements. In contrast to the devices of the prior art, in the case of the device of the present invention not only a force vertical to the platform is executed but also a traction force substantially parallel to the platform. This results in a significantly improved biomechanical stimulation of the body part being located on the platform.

According to the present invention, a circular movement is preferred. According to the present invention, by a “circular movement” a movement is meant that does not deviate more than 5% from an ideal circular movement.

The axis around which the platform is moved in a circular manner can be located at random. It is preferred that this axis is located parallel to the base plate below the platform and in particular perpendicular to an axis which vertically extends through the pedestal.

It is preferred according to the present invention that the movement is carried out with a frequency of 5 to 35 Hz.

The circular or elliptical movement of the platform can be generated by common driving units which are known to the skilled man. According to the present invention it is preferred that the movement be generated by an eccentric drive. The eccentric drive is well known to the skilled man and does therefore not have to be explained in detail here. According to the present invention, the shaft of an eccentric drive is connected to the platform via conventional units such as bars, castors, bearings, belts or gear wheels.

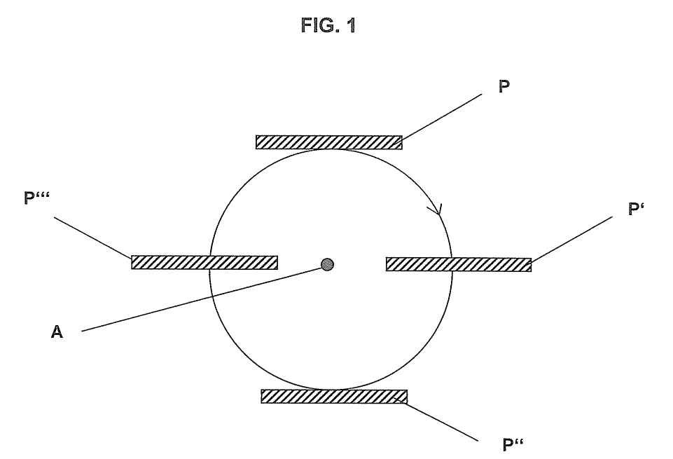

The movement executed by the platform is shown in FIG. 1 for the example of a circular movement. The platform P moves around the axis A. During this rotation, the platform P is thus tilted. Thereby, the platform P undergoes a parallel displacement. The platform P (i.e. the platform in the starting position) and the platform P′ (i.e. the platform after a rotation of 90°) as well as the platform P″ (i.e. the platform after a rotation of 180°) and the platform P′″ (i.e. the platform after a rotation of 270°) are thus parallel to each other, respectively. According to the present invention, the lift of the platform during this movement is preferably not more than 4 mm.

The device of the present invention may be used in the field of sports, cosmetics or health. In the field of sports, the buildup of muscles as well as the increase of the endurance performance of the user is in the primary focus. In the field of cosmetics, the device may be used, for example, against cellulites or the formation of wrinkles. In the health sector, the device of the present invention may be used for example in the following treatments: Weakness of connective tissue, degenerative rheumatic diseases, migraine, muscular tension or weakness, pain in the muscular or locomotor system, build-up of muscles in the case of amyotrophia of muscles, degenerative alterations of the spinal disk (arthosis), fractures, diseases of joints (e.g. of the elbow of persons exercising tennis or golf), lack of stability of joints, myelosis, problems related to the shoulder, the back, the hip, the knees or the ankle, problems with blood circulation, congestion syndromes (Ulcus cruris), resorption of edemas, neuropathies, strengthening the metabolism, aconuresis, multiple sclerosis, muscle dystrophy, Parkinson disease, stroke, arthrogenic (venous) congestive syndrome, Ehlers-Danlos syndrome, Sklerodermia, Periodontosis problems with the mandible joints, improvement of blood circulation in the visual nerve, strengthening the muscles of the circumorbital ring, Facial nerve paresis, problems related to the frontal and maxillary sinuses, chronic rhinitis, Tinnitus aurium and Osteoporosis.

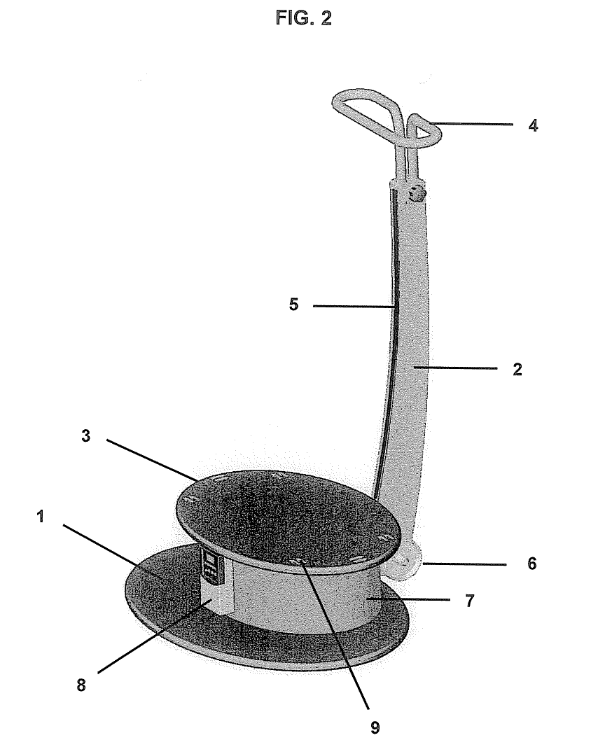

Below, a preferred embodiment of the device of the present invention is shown with reference to FIG. 2.

On a portion of an oval base plate 1, a pedestal 2 having an L-form is provided, the shorter portion of which being surrounded by a cover 7. In an opening situated in this shorter portion of the pedestal 2, the driving unit for the platform 3 is provided. In this example, said driving unit is an eccentric drive evoking the circular movement of the platform 3. At the end of the shorter portion of the pedestal 2 having an L-form, there is additionally provided a user unit 8 for controlling the device of the present invention. At the lower end of the pedestal 2, two wheels 6 are provided in order to allow a more simple transportation of the device of the present invention. At the upper end of the longer portion of the pedestal 2 having an L-form, there is provided a grip 4 at which a user may hold himself during usage of the device of the present invention. Along the longer portion of the pedestal 2 having an L-form, there is provided a ribbon 5. The ribbon 5 is electrically connected with the driving unit in the pedestal 2. By pushing the ribbon 5, the device of the present invention may be controlled. The platform 3 is moveably connected with the driving unit which is located in the pedestal 2 (in its portion which is surrounded by the cover 7), so that the platform 3 may be moved in a circular or elliptical fashion by the driving unit. As can be gathered from FIG. 2, the surface of the platform 3 has a lower surface area than the surface of the base plate 1. Therefore, during usage the user may stand also on the base plate 1, and only locate specific body parts on the platform 3, allowing a specific BMS of those body parts. Moreover, on the platform 3 there are openings 9. Through these openings, cords or ribbons for additional exercises may be provided.

What is claimed is:

1-10. (canceled)

11. Device for biomechanical stimulation, comprising a base plate, a pedestal connected with said base plate and a platform connected to said pedestal via a driving unit, characterised in that said platform during usage executes a circular or elliptical movement about an axis which is located outside of the centre of gravity of the platform, thereby undergoing a parallel displacement.

12. Device according to claim 11, wherein said platform has an ergonomic form and a lower surface area than the surface of the base plate.

13. Device according to claim 11, wherein said platform is brought into a circular or elliptical movement by means of an eccentric drive.

14. Device according to claim 11, wherein said base plate is fixed by applying a weight.

15. Device according to claim 11, wherein wheels are provided for transport of said device.

16. Device according to claim 11, wherein said wheels are provided in the vicinity of the connection of pedestal and base plate.

17. Device according to claim 11, wherein units for controlling said device are provided at the pedestal.

18. Method for biomechanical stimulation of muscles, said method comprising the step of applying biomechanical stimulation by means of a device according to claim 11.

19. Method of increasing the blood circulation of a body part, said method comprising the step of increasing said blood circulation by means of a device according to claim 11.

20. Method of build-up of muscles, said method comprising the step of building up muscles by means of a device according to claim 11.
